(19) United States
(12) Patent Application Publication
(10) Pub. No.: US 2022/0053702 A1
(43) Pub. Date: Feb. 24, 2022

(54) COMBINE FEEDERHOUSE WITH CROP FLOW SPLITTER

(71) Applicant: AGCO International GmbH, Neuhausen (CH)

(72) Inventor: Jonas Toft ANDERSEN, Randers (DK)

(21) Appl. No.: 17/409,290

(22) Filed: Aug. 23, 2021

(30) Foreign Application Priority Data
Aug. 24, 2020 (GB) 2013197.5

(51) Int. Cl. A01D 61/04; A01D 61/00

(52) U.S. Cl. CPC A01D 61/04; A01D 61/008

(57) ABSTRACT

A combine harvester includes a feederhouse mounted to a chassis. The feederhouse is adapted at a front end to support a crop gathering header in a manner that places a front inlet in communication with a discharge opening of the header. The feederhouse defines a crop conveying passage and includes a chain and slat conveyor arranged in the passage to convey a crop stream rearwardly from the front inlet over a floor. A longitudinally-aligned ridge is provided on the floor for dividing the crop stream.

### CROSS-REFERENCE TO RELATED APPLICATION

This application claims the benefit of the filing date of United Kingdom Patent Application 2013197.5, filed Aug. 24, 2020.

### FIELD

The invention relates to combine harvesters and particularly to feederhouses for combine harvesters that are mounted to a chassis and adapted at a front end to support a crop gathering header in a manner that places a front inlet in communication with a discharge opening of the header, the feederhouse defining a crop conveying passage and comprising a floor and a chain and slat conveyor arranged in the passage to convey a crop stream rearwardly from the front inlet over a floor.

### BACKGROUND

Self-propelled combine harvesters have been used by farmers since the early twentieth century to harvest grain crops from fields. Since then the basic architecture of the crop processing system employed has not changed significantly and is well known. The combine typically comprises a cutting header that is detachably supported on the front of a feederhouse which is pivotable about a transverse axis x to lift and lower the header.

As the combine is driven across a field of standing crop the header serves to cut and gather the standing crop material before conveying such as a crop material stream into the feederhouse. A chain and slat elevator is typically housed within the feederhouse and serves to convey the crop material stream upwardly and rearwardly from the header to the crop processor. U.S. Pat. Nos. 3,785,472 and 7,473,168 disclose example feederhouses with chain and slat elevators.

The crop material is subsequently conveyed into threshing and separating apparatus sometimes via one or more tangential-flow feed beaters. Whilst many ‘conventional’ combines employ tangential-flow threshing cylinders, higher capacity machines tend to utilize one or two axial-flow rotors that are operable to rotate in respective longitudinally-aligned foraminous housings. In ‘hybrid’ machines the axial-flow rotors tend to primarily perform a separating function only, whereas in ‘pure axial’ machines the rotors perform both a threshing and a separating function.

For those combines with twin axial-flow rotors disposed side-by-side, the crop material stream delivered by the feederhouse is divided whereupon respective portions are fed to the separate rotors. The division of the crop material stream has presented challenges. If not divided effectively, the crop material can impinge upon the smooth flow and cause blockage immediately in front of the rotors. It is known to provide directional elements (vanes for example) on a feed beater that feeds crop material from the feederhouse toward the rotors, the elements being angled with respect to both the radius and the rotation axis of the beater and serving to impart a sideways (or transverse) force on the conveyed crop material. U.S. Pat. Nos. 8,556,690 and 5,454,758 disclose examples of such directional elements.

Whilst the directional vanes provide some degree of lateral division of the crop material stream, they struggle to provide effective division with the increased throughputs of higher capacity machines.

### SUMMARY

In accordance with an aspect of the invention a longitudinally-aligned ridge is provided on a floor of the feederhouse for dividing the crop stream. Advantageously, division of the crop material stream is started further upstream than in known combines and the crop flow immediately ahead of the crop processor is improved, reducing the frequency and risk of blockages and downtime.

### BRIEF DESCRIPTION OF THE DRAWINGS

Further advantages of the invention will become apparent from reading the following description of a specific embodiment with reference to the appended drawings in which:

FIG. 1 is a schematic side view of combine harvester comprising a twin axial-flow crop processor in accordance with an embodiment;

FIG. 2 is a schematic vertical section of the feederhouse of the combine of FIG. 1 viewed along the line 2-2 as shown in FIG. 3;

FIG. 3 is a schematic plan view of the feederhouse of FIG. 2 with the top panel omitted to reveal the chain and slat conveyor housed therein, the view also including the feed beater and front portion of the rotors;

FIG. 4A is a schematic vertical section view of the ridge disposed on the feederhouse floor, along line a-a, shown in FIG. 3;

FIG. 4B is a schematic vertical section view of the ridge disposed on the feederhouse floor, along line b-b, shown in FIG. 3;

FIG. 4C is a schematic vertical section view of the ridge disposed on the feederhouse floor, along line c-c, shown in FIG. 3; and

FIG. 5 is a perspective view of the chain and slat conveyor of FIG. 2.

### DETAILED DESCRIPTION OF A SPECIFIC EMBODIMENT

Aspects of the invention will now be described in connection with various preferred embodiments implemented on a combine harvester. The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

Relative terms such as front, rear, forward, rearward, left, right, longitudinal and transverse will be made with reference to the longitudinal vehicle axis of the combine harvester travelling in the normal direction of travel. The terms “direction of conveyance”, “upstream” and “downstream” are made with reference to the general flow of crop material through the combine harvester, or to the cleaning airstream through the screening apparatus.

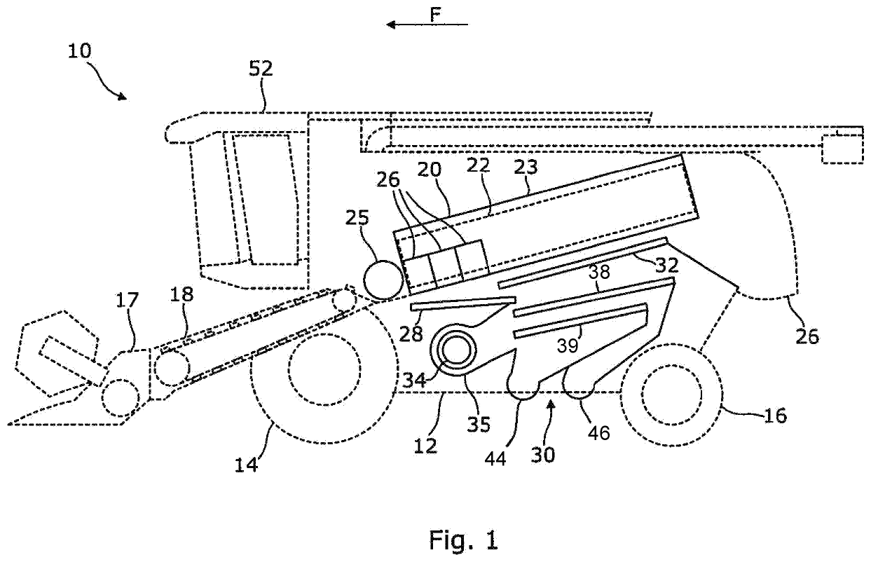

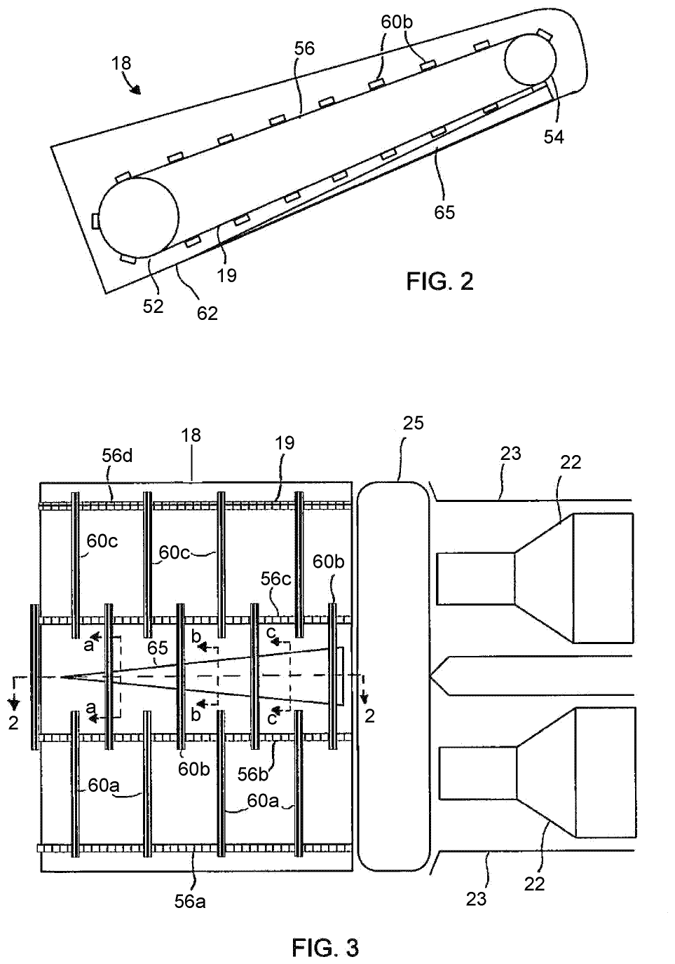

With reference to FIG. 1 a combine harvester 10 includes a frame or chassis 12, front wheels 14 and rear steerable wheels 16. A cutting header 17 is detachably supported on the front of a feederhouse 18 which is pivotable about a transverse axis to lift and lower the header 17 in a conventional manner.

The combine 10 is driven in a forward direction F across a field of standing crop in a known manner. The header 17 serves to cut and gather the crop material before conveying such into feederhouse 18 and elevator 19 housed therein. At this stage the crop stream is unprocessed. It should be understood that combine harvesters are employed to harvest a host of different crops including cereal, rice, corn and grass seed. The following description will make reference to various parts of the cereal crop stream but it should be understood that this is by way of example only and does not by any means limit the applicability of the invention to harvester other harvesting crops.

The cut crop stream is conveyed rearwardly from the feederhouse 18 to a processor designated generally at 20. The processor 20 is of the axial rotary type having a pair of axial-flow threshing and separating rotors 22 which are each housed side-by-side inside a respective rotor housing 23 and are fed at their front end by a feed beater 25 which may be constructed as disclosed in U.S. Pat. No. 10,091,941.

It should be appreciated that the right-hand rotor is hidden from view in FIG. 1. The rotors 22 serve to thresh the crop stream in a front ‘threshing’ region, separate the grain therefrom in a rear ‘separating’ region, and eject the straw residue through the rear of the machine 26 either directly onto the ground in a windrow or via a straw chopper (not shown).

Each rotor housing 23 is generally cylindrical and is made up of an opaque upper section and a foraminous lower section which includes a set of side-by-side arcuate concave grate segments 26 extending the length of the front threshing region and which allow the threshed material to fall by gravity onto a grain collection pan 28 located below for onward conveyance to a grain cleaning system which is designated generally at 30. Guide vanes (not shown) are secured to the inside of the rotor housing and serve, in conjunction with the crop engaging elements on the rotor 22, to convey the stream of crop material in a generally rearward spiral path from front to rear.

The separating region at the rear portion of rotors 22 comprises plural crop engaging elements (not shown) to separate the residual grain from the stream of crop material. A grain return pan 32 is provided underneath the separating region to collect the separated grain and convey it forwardly for delivery onto the grain collection pan 28. Both the collection pan 28 and return pan 32 are driven so as to oscillate in a known manner.

The grain cleaning system 30 comprises a fan 34 housed in a fan housing 35. The fan 34 may be of a known type such as a crossflow or centrifugal fan that rotates on a transverse axis and draws in air either tangentially or axially through air intake openings. A cleaning airstream is generated by the fan 34 and exhausted from the fan housing 35 in a generally rearward and upward direction.

The grain cleaning system further comprises an upper sieve 38 (alternatively referenced ‘chaffer’) and a lower sieve 39. The sieves 38,39 are driven with an oscillating motion in a known manner. The sieves 38,39 are mounted between side members of a shoe frame which is suspended on hangers (not shown) from the frame 12 and driven in an oscillating motion.

The sieves 38,39 each comprise a plurality of transverse louvres which can be adjusted either manually or remotely to adjust the coarseness of the screen provided. The louvres are arranged in a parallel transverse relationship and pivot to adjust the opening or gap between adjacent ones.

The threshed material comprising a mixture of grain and MOG is conveyed by the grain collection pan 28 in a rearward direction until it falls from a rear edge and into the grain cleaning system 30. The cleaning airstream is directed through and over the sieves 38,39 in a known manner so as to lift the lighter material, primarily MOG, away from the surface of upper sieve 38 and in a rearward direction for ejection at a rear outlet 42.

In a known manner, the cleaning system 30 is operable to allow the clean grain to pass through the sieves 38,39, wherein the clean grain is collected in a transverse clean grain trough 44 and conveyed onwards to an on-board grain tank (not shown). The louvres of upper sieve 38 may be set to allow unthreshed heads to pass through a rear region of the upper sieve 38 into a tailings collection trough 46. Likewise, any material screened out by lower sieve 39 falls from the rear edge thereof into the tailings collection trough 46 from where the ‘returns’ are fed back to the processor 20 or a dedicated rethreshing system (not shown).

Turning attention back to the feederhouse 18 and conveyor 19, front and rear rollers 52, 54 are journaled between two sidewalls of the feederhouse for rotation on mutually parallel transverse axes. One or both of the rollers 52,54 are driven in a known manner. A plurality of continuous chains 56a-d, four in the illustrated example, are trained around the front and rear rollers 52,54 with sprockets 58 keyed onto the rear roller 54 for delivering the drive to the chains.

Adjacent pairs of chains 56a-d have secured therebetween a plurality of slats 60 which extend at substantially right angles to the direction of movement of the chains 56 and serve to sweep crop material through the feederhouse, along the floor 62 in a rearward direction, when passing along a lower run between the rollers 52,54 in a known manner. A first run of slats 60a is provided between the first and second chains 56a,b. a second ‘middle’ run of slats 60b is provided between the second and third chains 56b,c. A third run of slats 60c is provided between the third and fourth chains 56c,d.

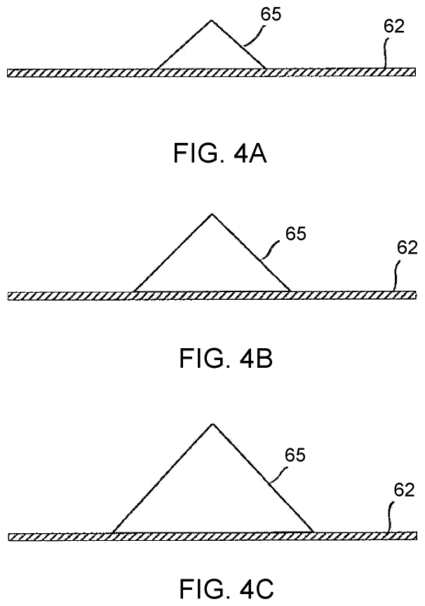

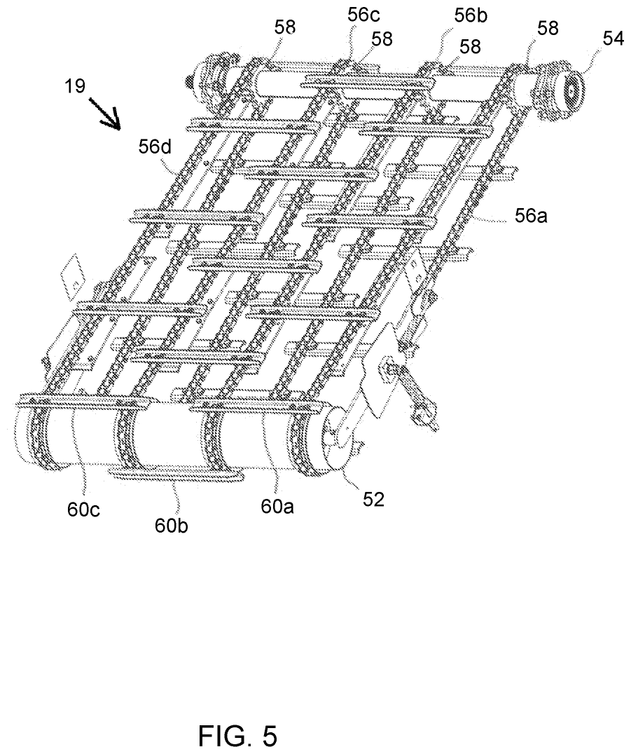

In accordance with an aspect of the invention a longitudinally-aligned ridge 65 is provided on the floor 62 for dividing or laterally shifting the crop stream into a left-hand and right-hand sub-stream. The ridge 65 preferably has a width that increases continuously in a crop conveyance direction from front to rear. The ridge 65 preferably has a height that increases continuously in the crop conveyance direction. As seen in FIG. 4, in one embodiment the ridge 65 has a triangular section, preferably an equilateral triangular section, that increases in both width and height in the rearward direction, that is the general direction of crop conveyance.

The ridge 65 may be formed of steel or other suitable wear-resistant material, and is fastened to the floor 62 by suitable means, such as welding, riveting or gluing for example.

The ridge 65 is disposed centrally with respect to a width of the floor 62. The ridge 65 preferably extends along a majority of the length (fore-aft direction) of the floor 62.

In operation the slats 60b of the central run slide over ridge 65. Crop material engaged between the slats 60b and the ridge 65 is shifted laterally by paths of less resistance presented down both sides of the ridge 65, thereby acting to divide the crop stream into two sub-streams.

Each of the slats 60b of the central run may include a replaceable wear part which contacts the ridge during operation. The wear part may be formed of plastic for example.

All references cited herein are incorporated herein in their entireties. If there is a conflict between definitions herein and in an incorporated reference, the definition herein shall control.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope as contemplated by the inventors. Further, embodiments of the disclosure have utility with different and various machine types and configurations.

1. A combine harvester comprising:
a chassis;
a feederhouse mounted to the chassis and being adapted at a front end to support a crop gathering header in a manner that places a front inlet in communication with a discharge opening of the header, the feederhouse defining a crop conveying passage and comprising:
a floor;
a chain and slat conveyor arranged in the passage to convey a crop stream rearwardly from the front inlet over the floor; and,
a longitudinally-aligned ridge provided on the floor for dividing the crop stream.

2. A combine harvester according to claim 1, wherein the ridge has a width that increases continuously in a crop conveyance direction.

3. A combine harvester according to claim 1, wherein the ridge has a height that increases continuously in a crop conveyance direction.

4. A combine harvester according to claim 1, wherein ridge is disposed centrally with respect to a width of the floor.

5. A combine harvester according claim 1, wherein the chain and slat conveyor comprises a plurality of slats disposed to slide over the ridge, each of the plurality of slats has a replaceable wear part which contacts the ridge during operation.

6. A combine harvester according to claim 1, further comprising a pair of axial-flow crop processing rotors having respective rotation axes which are aligned fore and aft and mutually side-by-side, wherein each crop processing rotor is arranged to receive a respective portion of the crop stream divided by the ridge.
